(19) United States
(12) Patent Application Publication
(10) Pub. No.: US 2012/0209911 A1
(43) Pub. Date: Aug. 16, 2012

(54) METHOD OF MONITORING A BITTORRENT NETWORK AND MEASURING DOWNLOAD SPEEDS

(75) Inventors: Georgios Siganos, Madrid (ES); Pablo Rodriguez Rodriguez, Madrid (ES)

(73) Assignee: TELEFONICA, S.A., Madrid (ES)

(21) Appl. No.: 13/383,989

(22) PCT Filed: Jul. 14, 2009
(86) PCT No.: PCT/EP2009/058970

§ 371 Date: Apr. 26, 2012

(51) Int. Cl. G06F 15/16

(52) U.S. Cl. 709/204

(57) ABSTRACT

The invention discloses a method of monitoring a bittorrent network and measuring download speeds. The speed is calculated by connecting to a client, getting the bitfield and have messages, reconnecting after a predetermined time and getting a new bitfield and have messages. Taking the number of new pieces between both observations multiplied by the piece size and divided by the time between the two observations the download speed is obtained.

### FIELD OF THE INVENTION

The present invention relates to peer to peer networks, in particular to a method of monitoring a bittorrent protocol and measure the download speeds of clients in such a network.

### STATE OF THE ART

The Bittorrent protocol is a p2p protocol designed for bulk data transfers. Bittorrent has three main ingredients: a) a metadata file called a torrent that contains essential information on how to connect to the network or swarm, b) a central server called tracker that coordinates the clients or peers, c) the notion of breaking the file or files into pieces that can be downloaded and uploaded in parallel.

In order to download a file, a user will need to find the torrent file. The torrent file contains the id or “infohash” of the torrent, the address of the tracker and information like the size of the file, the number of pieces that the file is broken into, the piece size and other related information. The client then contacts the tracker for other peers to connect to, and tries to open connections to these clients. After connecting successfully, it will send the bitfield, an array of 0 and 1 that describes the pieces it has (0 means it does not have the piece, while 1 means it has it), and a string that describes what its capabilities are. For example, the clients can support Peer Exchange messages (PEX), which can be used to learn about other peers. When a client downloads successfully a piece, it will notify its neighbors that it has the piece.

Monitoring the Bittorrent network has been studied before, with the most relevant work to be the BitProbe measurement system. This system though is focused in measuring the characteristics of the line of an end user, for example line capacity, and also evaluating the effectiveness of the Bittorrent application.

A problem still to be solved in this technical field is how to monitor a Bittorrent network and measure the download speeds of Bittorrent clients without deploying Deep Packet Inspection (DPI) equipment within the network of an Internet Service Provider (ISP). DPI systems are expensive to acquire and deploy, and can only capture the behavior of part of the network. Additionally, installing such devices requires the consent and cooperation of the ISPs. The system needs to have the following requirements: a) be as light-weight as possible, b) be capable of monitoring hundreds of thousands or millions of clients within a small time window, c) not be too intrusive for the clients and inflict the minimum possible overhead to them, and d) be fault-tolerant.

### DESCRIPTION OF THE INVENTION

To estimate the download speeds of Bittorrent clients while solving the technical problems discussed above, the invention proposes a method according to claim 1. Optional and advantageous features can be found in the dependent claims. The procedure is generally as follows:
1. Connect to a client, get its bitfield and have messages.
2. If the client has finished downloading the file, which is indicated by a bitfield with only ones (1), after 1 minute disconnect and exit. If the client is still downloading the file, as indicated by the missing pieces (zeroes) in its bitfield, after 1 minute disconnect, sleep for 4 minutes.
3. Then reconnect and get the new bitfield and have messages.
4. The estimate of the speed is given by the number of new pieces that the client downloaded between the two observations, multiplied by the piece size and divided by the time between the two observations.

### BRIEF DESCRIPTION OF THE DRAWINGS

To complete the description and in order to provide for a better understanding of the invention, a set of drawings is provided. Said drawings form an integral part of the description and illustrate a preferred embodiment of the invention, which should not be interpreted as restricting the scope of the invention, but just as an example of how the latter can be embodied. The drawings comprise the following figures:

FIG. 1 shows the high level interactions of the Torrent Process at a particular period of the year.

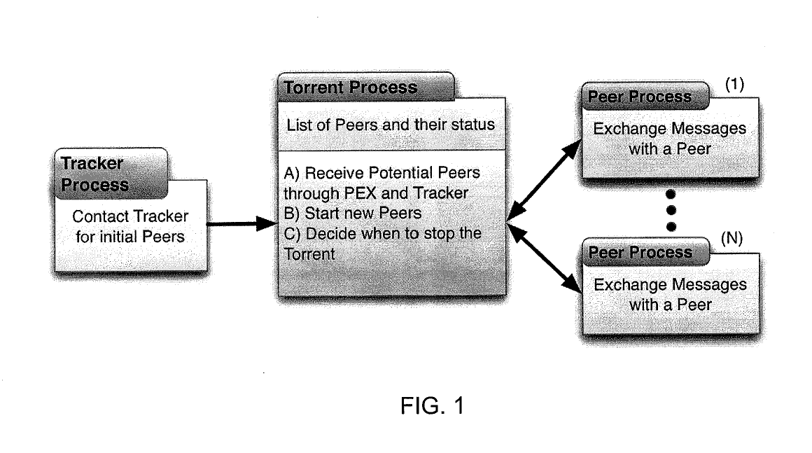

FIG. 2 shows the interactions between the client used by the invention and a Bittorrent client (Peer Process).

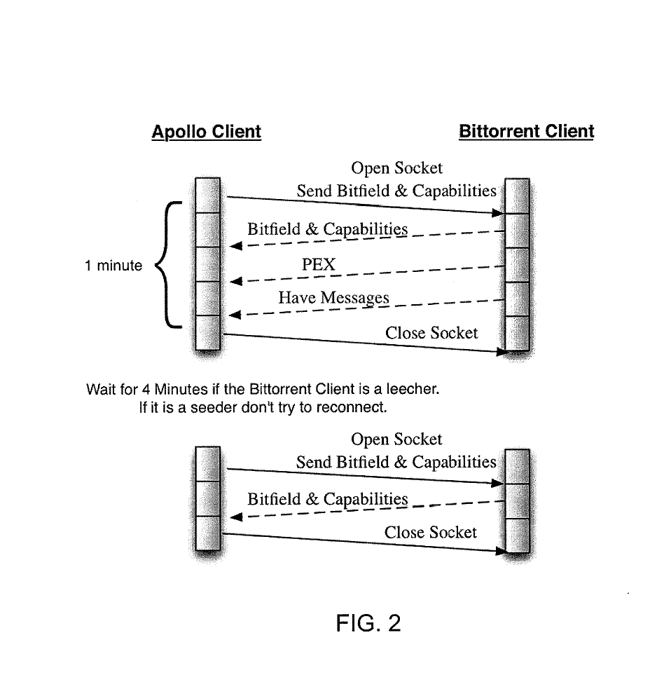

FIG. 3 is a graphical representation of the number of Bittorrent clients that can be analyzed with the present invention on an hour basis.

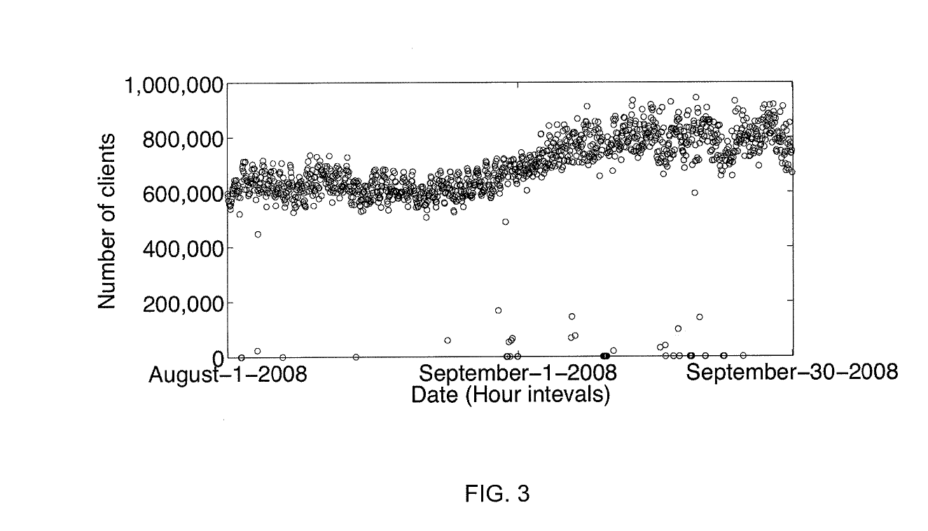

FIG. 4 is a representation of the measured performance of British Telecom during a 2 months period.

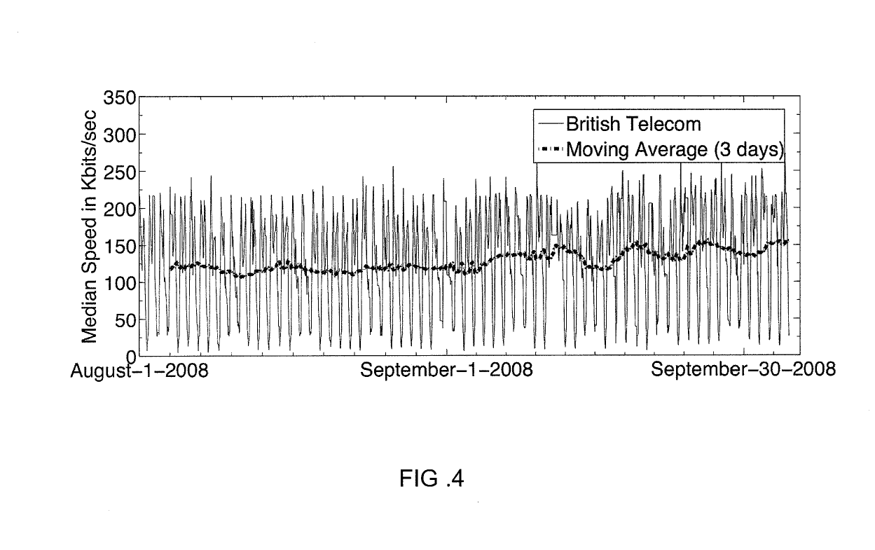

### DESCRIPTION OF A PREFERRED EMBODIMENT OF THE INVENTION

The invention provides a client that participates in bittorrent swarms and connects to other clients to measure how fast they download a torrent. As an input it gets a list of torrents to process and a timeframe to process them. At any given time, it analyzes in parallel a number of torrents. The client consists of a number of processes, which perform specific tasks. The Rate Controller process has the role of controlling the number of active torrents by constantly monitoring the CPU load and Memory usage of the local machine. The Manager process is the first process we start when we start analyzing a new torrent. It is responsible of starting all the necessary processes and passes to them the necessary references for message passing. The Manager process starts the Tracker process and the Torrent process. The Tracker process is responsible for the communication with the tracker. It registers with the tracker for the torrent, and gets the initial set of peers. The Torrent process keeps a list of the discovered peers and their status, i.e. if we are trying to connect, if we have finished analyzing them etc. For every new peer that we discover, the Torrent process starts a new process, Peer process that will be responsible for the communication with the peer. The Peer process has two goals. The main one is to get an estimate of the speed of the peer, if it is still downloading the file. The second goal is to get the PEX. The Torrent process, every one-minute checks the current status of the peers. In order to release resources like memory, we have put a cut off point. After we analyze 98% or more of the peers, we stop measuring the torrent and release the resources. The motivation behind this is that especially for very large torrents there is a constant flow of new peers that will not allow us to release resources needed to check other torrents.

Measuring the Download Speed:

To get an estimate of the download speed, the following high-level procedure is used:
1. Connect to a client get its bitfield and have messages.
2. If the client has finished downloading the file, after 1 minute disconnect and exit. The reason we exit is that a client that has finished downloading the file can not provide a download speed estimate.
3. If the client is still downloading the file, after 1 minute disconnect, sleep for 4 minutes.
4. Then reconnect and get the new bitfield and have messages. Disconnect and exit.

The estimate of the speed is given by the number of new pieces it downloaded between the two observations, multiplied by the piece size and divided by the time between the two observations.

Details:

In order to receive successfully Peer Exchange Messages, we stay connected the first time for 1 minute. This interval is the typical interval used. Once per minute, a bittorrent client that supports PEX, will send to all its peers either the list of its neighbors or a list of new and removed clients. Waiting for 1 minute guarantees that we will receive this data.

In case we cannot connect to a client, we have the following policy. If we could get no response, sleep for 10 seconds between failures and try at most 5 times. If we can open successfully a socket, but we cannot send successfully our bitfield, sleep for 10 seconds and re-try at most 2 times. Note, that to measure the speed of a bittorrent client we have to connect two times. This is not always feasible.

To decrease the load to the tracker, and to speed up the measurement, our main source of peers is PEX. In the typical case, that the torrent is not private, we query the tracker twice. If the torrent is private, which means that the creator of the torrent has explicitly forbidden the use of gossiping mechanisms like PEX and DHT, we have to depend on the tracker to learn the peers, since the peers we connect to will not send us any PEX. In that case, we use the scrape query of a tracker to learn the number of peers that participate and decide how many queries we need.

Incoming connections are not allowed in the present invention. The main reason is to decrease the necessary state required. Otherwise, the overhead to support the incoming connections compared to the benefit would be too high.

Problems to Avoid, Lazy Bitfield Effect:

Extra care is taken when analyzing the bitfield. A lot of clients implement a feature called lazy bitfield, where a client does not send the actual bitfield but removes from the bitfield a number of pieces, and then subsequently notifies the client that it has these pieces by using have messages. Thus, the have messages are required to eliminate this lazy bitfield problem.

This is done to avoid being detected as a bittorrent client which has finished downloading and being throttled by ISPs. To be sure that we collect all these have messages we stay connected for 10 seconds the 2nd time. We follow a very simple rule on the have messages. If the client supports the lazy bitfield feature, any have messages that it receives within 3 seconds are considered to be associated with this feature.

The system can be used to access performance differences between ISPs and understand the different policies that they utilize. Using the client of the invention we can understand and discover the fastest ISPs around the world without the need to install specialized DPI techniques and equipments and without getting the consent of the ISPs. Finally, it is easy to understand the throttling periods where ISPs don't want bittorrent users to exchange traffic.

In this text, the term “comprises” and its derivations (such as “comprising”, etc.) should not be understood in an excluding sense, that is, these terms should not be interpreted as excluding the possibility that what is described and defined may include further elements, steps, etc.

On the other hand, the invention is obviously not limited to the specific embodiment(s) described herein, but also encompasses any variations that may be considered by any person skilled in the art (for example, as regards the choice of materials, dimensions, components, configuration, etc.), within the general scope of the invention as defined in the claims.

1. A method of monitoring a bittorrent network and measuring download speeds, the method comprising the steps of:
a. connecting to a client, getting the bitfield and have messages
b. reconnecting after a predetermined time and getting a new bitfield and have messages
c. calculating the speed as the result of taking the number of new pieces between both observations multiplied by the piece size and divided by the time between the two observations.

2. The method of claim 1 wherein
if the client has finished downloading the file, disconnect after 1 minute
if the client is still downloading, disconnect after 1 minute, sleep for 4 minutes and proceed with b.

3. The method of claim 1 wherein, if the have messages incorporate a lazy bitfield, the reconnection in step b. has a duration of 10 seconds.

4. The method claim 1 wherein, in case where a client cannot be connected, the steps a and b are separated by 10 seconds between failures, the process being repeated at most 5 times if the failure persists.
